(19) United States
(12) Patent Application Publication
(10) Pub. No.: US 2023/0193703 A1
(43) Pub. Date: Jun. 22, 2023

(54) SPHERICAL SAND SEPARATOR FOR PETROLEUM AND NATURAL GAS WELLS

(71) Applicants: KEITH L. BOYD, Mineral Wells, TX (US); SCOTTY L. WHITSETT, Mineral Wells, TX (US); KEVIN J. KINDER, Mineral Wells, TX (US)

(72) Inventors: KEITH L. BOYD, Mineral Wells, TX (US); SCOTTY L. WHITSETT, Mineral Wells, TX (US); KEVIN J. KINDER, Mineral Wells, TX (US)

(21) Appl. No.: 17/755,999

(22) PCT Filed: Jan. 10, 2022
(86) PCT No.: PCT/US22/11758

§ 371 Date: May 13, 2022

Related U.S. Application Data
(60) Provisional application No. 63/136,198, filed on Jan. 11, 2021.

(51) Int. Cl. E21B 21/00; B01D 21/24

(52) U.S. Cl. CPC E21B 21/002; B01D 21/245; B01D 21/2411; B01D 21/2494; B01D 2221/04

(57) ABSTRACT

A sand separator for capturing solid debris from oil and gas wells includes a spherical, high-pressure vessel adapted to couple downstream of a wellhead. Fluid entering the separator follows a helical path around a vertical separator axis, slowing and separating into water, gas, oil and solid debris, the latter sinking to the bottom. A conical, downwardly opening flue descends from an exit port at the top and terminates in a horizontal, coaxial perimeter. A scalloped, annular collar inside the flue perimeter creates a low barrier to fluid flow into the flue. As fluid constituents circulate toward the flue, they recombine free of sand and rock debris, pass under the flue perimeter and across the collar, slowing further and becoming substantially laminar A fluid dome rises inside the flue with a gas layer above other fluid constituents, permitting the gas to exit the separator through the exit port.

### CROSS REFERENCE TO RELATED APPLICATION

This application claims domestic benefit from U.S. Provisional Application Ser. No. 63/136,198, filed Jan. 11, 2021. The contents thereof are incorporated by reference herein in their entirety.

### BACKGROUND OF THE INVENTION

### 1. Field of the Invention

This invention relates generally to petroleum and natural gas wells, and particularly to wellhead site equipment. More particularly, it relates to a spherical sand separator installed at the wellhead upstream of other surface equipment for separating solid debris from well effluent fluids.

### 2. Description of Related Art

Exploration for underground, fluid hydrocarbons such as methane, or natural gas, often involves injection of high-pressure fluids (mostly water with sand) into underground rock formations expected to yield the hydrocarbons, a process commonly referred to as hydraulic fracturing. Water pressure fractures the rock strata, whereupon entrapped hydrocarbons escape into the well bore to be captured at the surface and piped to market. Hydraulic fracturing fluid is recovered from the exploration wells and disposed of, usually by hauling it off in trucks to a remote disposal site.

Fracturing fluid contains a considerable amount of fracturing sand which scours the formation to clean and etch it for maximum delivery. Sand also lodges in cracks created by fracturing fluid pressure and holds them open to maximize escape of hydrocarbons from the strata. Sand from fracturing fluid doesn't all lodge in the formation, however, some returning to the surface in “flowback” from the well. During flowback, the well disgorges fracturing fluid under pressure from the escaping hydrocarbons. The flowback fracturing fluid includes a significant quantity of the injected sand, as well as granular rock debris flushed from the rock strata by the fracturing and flowback stages. Such sand and debris can wreak havoc upon pressure and velocity reducing choke valves and upon relatively sensitive surface testing, metering and processing equipment. A need exists for means for eliminating sand and rock debris from returned hydraulic fracturing fluid.

Production wells likewise need protection from fracturing sand and granular rock debris. Hydrocarbons from producing wells comprise not only oil and gaseous methane, but myriad other liquid byproducts, some of which are valuable (e.g. petroleum and natural gas distillates) and others of which are waste (e.g. stratigraphic saline and residual fracturing fluid), both of which may include significant quantities of sand. Surface equipment adapted for segregating well byproducts and for metering output from producing wells is vulnerable to damage from such debris. A need exists for means for separating solid materials such a sand and rock granules from producing well effluents.

Most prior art sand separators comprise vertical, cylindrical towers that stand eight (8 ft.) feet or more in height, have thick walls and are supported by a derrick or other stand. Such devices are exceptionally heavy, as they must withstand wellhead pressure while handling wellhead throughput volume. Such vessels also must be transported on roads and highways as oversized loads, requiring governmental special permits to do so. A need exists for a sand separator that can handle required wellhead pressures and volume throughput while remaining within overall size and weight parameters.

### SUMMARY OF THE INVENTION

A sand separator for capturing solid debris from oil and gas wells includes a spherical, high-pressure vessel adapted to couple downstream of a wellhead. Fluid entering the separator follows a helical path around a vertical separator axis, slowing and separating into water, gas, oil and solid debris, the latter sinking to the bottom. A conical, downwardly opening flue descends from an exit port at the top and terminates in a horizontal, coaxial perimeter. A scalloped, annular collar inside the flue perimeter creates a low-threshold barrier to fluid flow into the flue. As fluid constituents circulate toward the flue, they recombine free of sand and rock debris, pass under the flue perimeter and across the collar, slowing further and becoming substantially laminar. A fluid dome rises inside the flue with a gas layer above other fluid constituents, permitting the gas to exit the separator through the exit port.

### BRIEF DESCRIPTION OF THE DRAWINGS

The novel features believed characteristic of the present invention are set forth in appended claims. The invention, as well as a preferred mode of use and further objects and advantages thereof, further will be understood by reference to the following detailed description of one or more illustrative embodiments when read in conjunction with the accompanying drawings, wherein:

FIG. 1 depicts in elevated, quartering perspective. the exterior of the separator of the present invention

FIG. 2 represents a vertical cross section showing interior features of the apparatus of FIG. 1.

FIG. 3 is a section similar to FIG. 2 shown in elevated perspective to emphasize the geometry of fluid flow within the interior of the apparatus of FIG. 1.

FIG. 4 shows steady-state fluid behavior within the interior of the separator of FIG. 1.

FIG. 5 details, as shown in FIG. 4, the manner by which gas enters the flue apparatus of FIG. 1.

### DESCRIPTION OF A PREFERRED EMBODIMENT

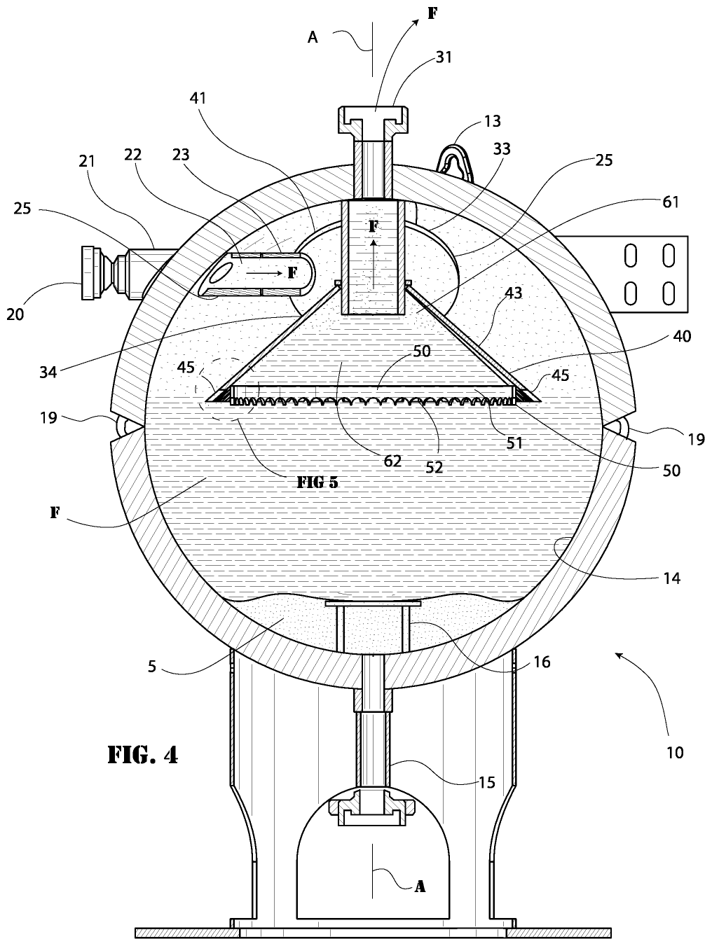

Referring to the figures, the present invention comprises a sand separator having a tank 10 with vertical axis A surrounded by upper, hemispherical dome 11 atop lower, hemispherical basin 12. Tank 10 is supported at a select height above a resting surface (not shown) by stand 17 sufficiently high to allow access to debris exit port 15, discussed in more detail below. Top dome 11 also may include one or more lifting lugs 13 for maneuvering separator 10 between a transportation vehicle (not shown) and said resting surface at an installation site. Separator tank 10 is adapted to be installed adjacent said wellhead with axis A oriented substantially vertically. Vertical orientation takes advantage of gravity to encourage debris 5 to fall to the bottom of lower basin 12 for removal through a sand outlet, including debris exit port 15 and sand shield 16. Accumulated sand 5 (FIG. 4) comprises a relatively viscous but fluid sand/water slurry, substantially under wellhead pressure within separator tank 10. Opening sand exit port 15 allows the slurry to extrude out under pressure, abetting removal. The slurry first passes through a choke valve (not shown) to reduce its pressure and velocity and then through one or more control valves to a disposal site (neither shown). One having ordinary skill in the art will recognize that all known methods of disposal of sand 5 and water 3 are contemplated by the present invention.

Sand shield 16 straddles debris exit port 15 to support the weight of sand 5 and to prevent it from clogging sand exit port 15. Sand shield 16 preferably comprises a horizontal plate spanning outlet 15 and supported above it by at least three vertical legs. Sand 5 and other debris passes under said plate and between said legs to enter sand exit port 15. One having ordinary skill in the art will recognize that sand shield 16 may have other configurations, such as a sloped or domed plate and a different number of support legs, and that said support legs may be oriented other than vertically, without departing from the scope of the present invention.

The remaining fluid F, comprising mostly natural gas 1, oil and water 3, eventually exits sand separator tank 10 at fluid outlet 31 where it proceeds through velocity-reducing choke valves (not shown) and onward to be separated into its constituents and processed as production fluids. If the wellhead is a gas well, gas 1 is routed to accumulation tanks and/or pipelines (neither shown), while oil and liquid precipitates are routed to other storage means (not shown) for further refining. If it is an oil well, gas 1 may be flared. Water in both cases usually is a byproduct for disposal, as it cannot be re-used without significant processing because it is contaminated with fracturing fluid chemicals. One having ordinary skill in the art will recognize that the present invention is useful for sand and solid debris removal in all such situations.

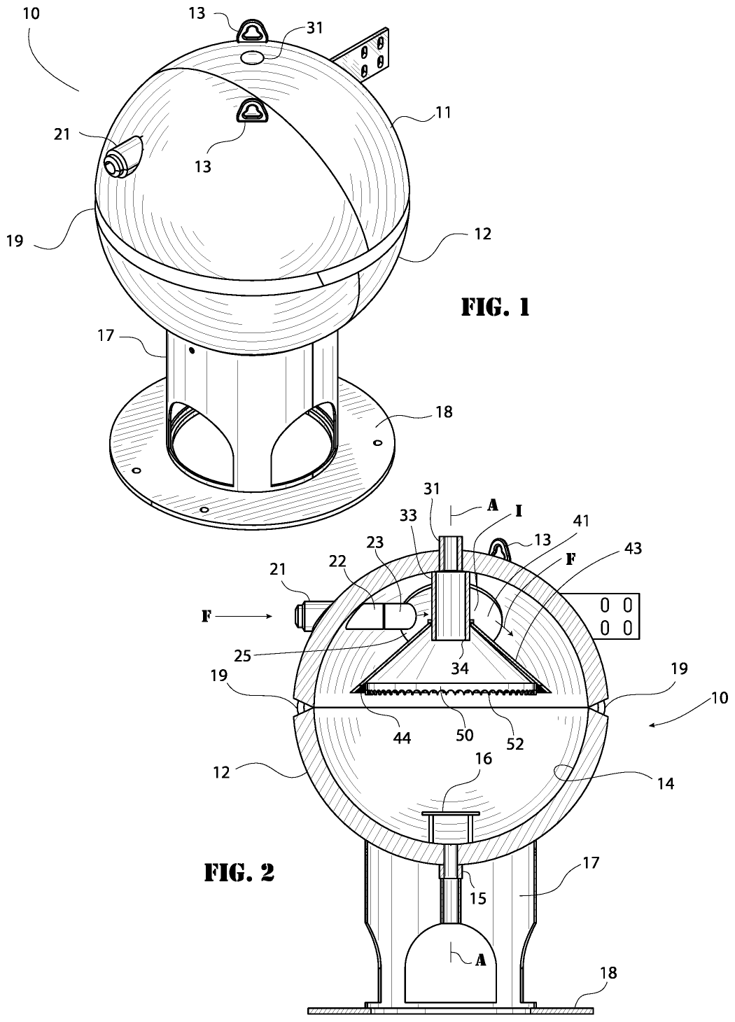

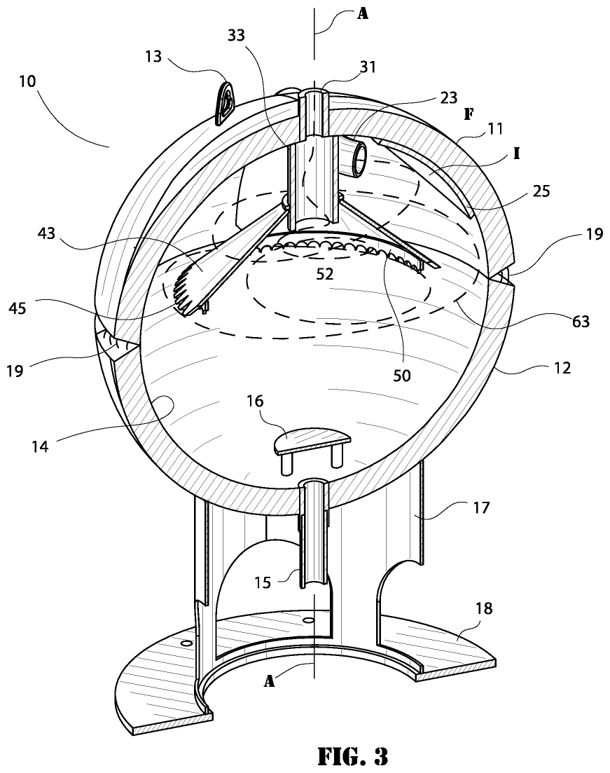

As best seen in FIGS. 2-4, wellhead fluid F enters separator tank 10 through inlet port 21 disposed through the walls of upper dome 11. Inlet 21 comprises nozzle 22 coupled to and in fluid communication with the wellhead and conveying fluid F into tank interior 14 of separator tank 10. Nozzle 22 extends into tank interior 14 a spaced distance, preferably radially toward axis A. Further, nozzle 22 preferably enters tank interior 14 within an entry plane substantially normal to axis A and thereby substantially horizontally. One having ordinary skill in the art will recognize, of course, that both of such angles (horizontal and radial) relative to axis A at which nozzle 22 enters tank interior 14 can vary significantly without departing from the scope of the present invention. In a particular embodiment, the entry plane is disposed approximately half way between the top of dome 11 at fluid outlet 31 and the midpoint of vertical axis A where the perimeters of dome 11 and basin 12 meet. One having ordinary skill in the art will recognize, of course, that the vertical position of the entry plane must remain within dome 11 but otherwise can vary significantly without departing from the scope of the present invention.

Disposed on the interior end of nozzle 22 distal inlet 21, diverter 23 redirects fluid F toward the interior wall of upper dome 11, preferably, but not necessarily, still within said entry plane. Diverter 23 deflects fluid F at an angle, preferably an obtuse angle, to the centerline of nozzle 22. This causes fluid F to encounter the concave wall of upper dome 11 at impact location I (FIG. 3) offset a spaced angular displacement around the interior perimeter of dome 11 from the point of entry of nozzle 22 into tank interior 14.

One having ordinary skill in the art will recognize that the location of impact point I and the angle at which fluid F encounters the walls of dome 11 may vary. In a particular embodiment, impact location I is between forty-five (45 deg.) degrees and one hundred thirty-five (135 deg.) degrees. In another particular embodiment, impact location I is substantially ninety (90 deg.) degrees offset from inlet port 21, whereby fluid F impacts the walls of dome 11 at substantially forty-five (45 deg.) degrees of angle. Diverter 23 accordingly is at substantially forty-five (45 deg.) degree angle to nozzle 22. Thus, fluid F impacts the walls of dome 11 at a significant angle, and is deflected by said walls to circulate around dome 11. Because dome 11 walls are generally concave downward, fluid F also is diverted and downward toward and into basin 12 in a substantially helical path.

Disposed across and on either side of said impact location I, concave erosion plate 25 intercepts fluid F as it encounters the curved walls of dome 11. Erosion plate 25 retards erosion caused by fluid F still under substantially full wellhead speed and pressure and bearing significant amounts of solid debris particles. Preferably, erosion plate 25 is sufficiently large and shaped to fully cover impacting fluid F and to protect dome 11 walls from erosion. In a particular embodiment, erosion plate 25 comprises a three-quarter (¾ in.) inch thick lamination of concave steel plate lining said upper dome wall, centered on location I and extending in both horizontal directions from location I approximately fifteen (15 deg.) degrees of angular displacement, as well as extending in both vertical directions for a displacement of approximately five (5 deg.) degrees.

As best seen in FIG. 3, fluid F circulates axially and helically downward around the interior walls of dome 11 and into basin 12, expanding and slowing as it goes. Further, fluid F spreads as it circulates, spiraling radially inward toward axis A, slowing still further. This spreading and slowing process causes solid debris such as sand 5 to precipitate out of solution and to settle toward sand outlet 15. Sand 5 periodically is removed through exit port 15, leaving a minimum level of sand 5 within lower basin 12 above which heavier liquid components of fluid F accumulate. Thus, lower basin 12 accumulates and stores not only sand 5 but also heavier liquid constituents of fluid F, freeing gas 1 to rise toward flue 40.

Continuing with FIGS. 2-4, downcomer 33 descends coaxial with axis A a spaced distance into interior 14 to terminate in downwardly opening mouth 34. Fluid F, substantially freed of solid sand and other debris 5, exits through mouth 34 to proceed to other production stages downstream of separator tank 10. In a particular embodiment, downcomer preferably is a six (6 in.) inch Schedule 40 or greater circular pipe reaching substantially twelve (12 in.) inches into interior 14 below outlet 31.

Coupled to downcomer 33 by clamp 44 a spaced distance above mouth 34, flue 40 comprises conical, downwardly opening chimney 43 that directs fluid F toward mouth 34. It has a horizontal, substantially circular perimeter forming a cone base approximately three-fourths of the diameter of separator 10 and a vertical height of approximately one-fourth of said diameter of separator 10. Chimney 43 couples to downcomer 33 about three and one-half (3½ in.) inches above mouth 34, and flares downward coaxial with vertical axis A to end in a margin or perimeter 44 disposed below the entry plane of nozzle 22. Thus, fluid F must flow downward, below perimeter 44, as described above, before it can enter outlet 31.

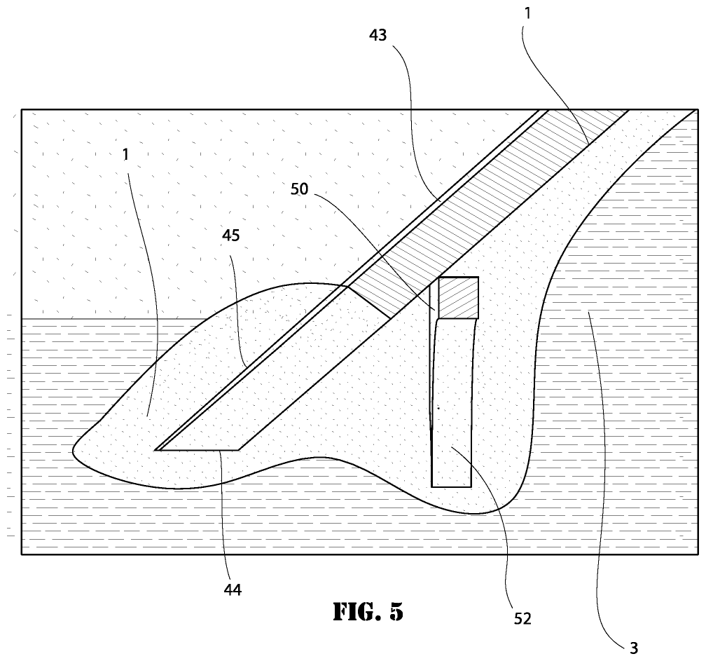

Arrayed around perimeter 44 of chimney 43, a plurality of radially outward facing notches 45 serve two purposes. First, notches 45 locate and assist press breaking of the plate steel of chimney 43 into radial bends which give it its conical shape, as discussed below. Second, notches 45 strain and break fluid F into a plurality of small rivulets (FIG. 5) as it flows around perimeter 44, thus inducing fluid F to flow in an even more laminar manner as it enters flue 40. Preferably, notches 45 for chimney 43 are evenly spaced and continuous around perimeter 44, giving chimney 43 a serrated margin. In a particular embodiment, notches 45 are approximately one (1 in.) inch wide at perimeter 44 and extend radially inward approximately one-and-one-fourth (1¼ in.) inches toward downcomer clamp 41. One having ordinary skill in the art will recognize that the number, shape and size of notches 45 are a design parameter selected for the wellhead shut-in conditions of a given gas field, and that all such numbers, shapes and sizes, including no notches 45 at all, are within the scope of the invention.

Disposed radially inward from perimeter 44 and coupled to the underside of chimney 43, annular collar 50 is coaxial with and parallel to axis A. Collar 50 attaches by its upper margin to the underside of chimney 43 with a continuous, fluid-tight weldment, and extends vertically downward to terminate approximately coplanar with perimeter 44. Preferably, collar 50 includes a plurality of downwardly opening, substantially semi-circular scalloped openings 52 along its lower margin. Scalloped openings 52 extend approximately half the height of collar 50, and match substantially the height and area of notches 45. Preferably, scalloped openings 52 are evenly spaced around the lower margin of collar 50 and angularly offset around axis A so that they do not line up with notches 45 in perimeter 44.

Collar 50 thus forms a short dam intercepting and diverting the flow of fluid F coming from notches 45. Fluid F passes under perimeter 44 through notches 45, and then encounters collar 50 which further slows it. The individual rivulets (not shown) of fluid F thus divert their pathway and flow through scalloped openings 52, slowing the speed of fluid F even further. In such manner, fluid F enters the interior of flue 40 far more calmly than it enters interior 14 of separator tank 10 at inlet 21. Fluid F remains under high pressure from the wellhead, but its speed has been reduced and its laminar flow increased as it approaches outlet 31.

Though fluid F entering flue 40 may contain other constituents, it primarily comprises gas 1, oil and water 3. This admix of gas and water is considerably lighter than fluid F had been when it entered separator 10 at inlet 21, largely because of the removal of solid debris 5. Under slower movement but continued wellhead pressure, some lighter constituents of fluid F, primarily gas 1, can separate out from fluid F and form pockets or layers of such undissolved constituents.

As it continues to circulate, fluid F rises buoyantly toward the top of flue 40, forming a fluid dome 62 comprising primarily fluid F substantially devoid of debris 5. Fluid dome 62 reaches toward, but never quite enters, mouth 34 of downcomer 33. Instead, a high-pressure gas dome 61 of undissolved gas 1 builds atop fluid dome 62 against the underside of chimney 43, the outer wall of downcomer 33 and above and across mouth 34 above fluid dome 62. Gas 1 thereby is channeled into downcomer 33 and exits separator tank 10 through outlet 31b. See FIG. 4.

Gas dome 61 has the effect of compressing other constituents of fluid F in fluid dome 62 which have not yet recombined with gas 1, said constituents largely being liquids such as water 3, oil and liquid gas precipitates. At the margin between fluid dome 62 and gas dome 61, gas 1 partially recombines with water 3 and oil from fluid dome 62, creating an admix of the lighter constituents of fluid F. The admix then flows into mouth 34 and through outlet 31, leaving heavier constituents of fluid F, including sand 5, inside separator tank 10.

### Fabrication

Preferably, diverter 23 comprises an angled portion of steel pipe similar to nozzle 22. One having ordinary skill in the art will recognize, however, that diverter 23 could be an elbow, angled deflector plate, or other device, and it could be reinforced against erosion, without departing from the scope of the present invention. Preferably, nozzle 22 comprises a high-grade steel pipe of at least Schedule 40 and having an inner diameter of substantially four (4 in.) inches. Chimney 43 preferably comprises a circular steel plate sufficiently thick to remain rigid though buffeted by the high speed and pressure of fluid F. Chimney 43 is formed into a truncated cone by press-breaking it at spaced intervals around its perimeter. In a particular embodiment, chimney 43 is one-half (½ in.) inch thick, has a base diameter of three (3 ft.) feet and a height of one (1 ft.) foot. Separator 10's dome 11 and basin 12 are fabricated from high strength steel of sufficient thickness to withstand fluid pressures from a natural gas wellhead (not shown) downstream of which separator 10 is coupled and with which it is in fluid communication. Dome 11 and basin 12 preferably are congruent and mate at their circular, hemispherical margins and sealed closed with weldment 19 also capable of withstanding said wellhead fluid pressures. One having ordinary skill in the art will recognize that separator 10 may vary in size and shell thickness depending upon the wellhead application for which it is designed.

Depending upon the pressures of the gas field in which said wellhead is located, shut-in pressures may range from as little as 1000 psig to as much as 15,000 psig. Further, gas well pressures from time-to-time may surge substantially above such typical field shut-in pressures. For greater wellhead shut-in pressures, larger diameter separators 10 create a trade-off between diameter and wall thickness. Finally, separator 10 also must be capable of the volume output of water and gas of said wellhead effluent fluid.

### Example 1

By way of a First Example, the hydrostatic pressures experienced during 2010 in the Barnett Shale gas field in and around Fort Worth, Tex., typically fell into the range of 1000-1500 psig. Volumes from the Barnett Shale play typically ran as much as 10 million cubic feet (MMCF/da.) of natural gas per day with a water content of 2000 barrels (bbls./da.) per day.

For such relatively low wellhead shut-in pressures at such volumes, a particular embodiment of separator 10 has an outside diameter of approximately fifty-four (54 in.) inches with approximately three (3 in.) inches of wall thickness. This provides an internal diameter of approximately forty-eight (48 in.) inches, resulting in an interior volume of approximately 33.5 cubic feet, a volume sufficient for most applications. This is the equivalent of almost three 16-inch diameter cylindrical sand separator towers standing eight feet tall, thus providing a significant efficiency in overall size and weight.

### Example 2

As a Second Example, a wellhead shut-in pressure of 5000 psig dictates that separator 10 walls must increase in thickness, possibly reducing the internal diameter of separator 10 too much for the expected throughput volumes. This requires that its outside diameter increase to accommodate thicker walls that can withstand the increased pressure while the internal diameter of separator 10 remains sufficiently large for the volume throughput of natural gas and fluid F. Thus, for the same throughput as the First Example above, separator 10 requires wall thicknesses of three and one-half (3½ in.) to four (4 in.) inches, requiring an outside diameter of two to four (2 in. to 4 in.) inches greater than the 54 inches of the First Example. This is a modest increase over the size requirement for the First Example, though its weight will increase noticeably.

### Operation

In operation, wellhead effluent fluid F enters separator 10 through inlet 21 and nozzle 22, at substantially unchoked wellhead pressures and velocity. Though fluid F immediately experiences a release of pressure because of the increased volume of interior 14 of separator 10 in contrast to wellhead piping (not shown), the pressure within separator 10 remains high. As fluid F circulates inside separator 10 and descends within tank interior 14, however, gas 1 separates from fluid F and rises to enter flue 40. With gas 1 released from the stream of fluid F now substantially containing mostly water 3 and sand 5, the velocity of fluid F slows considerably more. As fluid F drops low enough within tank interior 14 to enter flue 40 below perimeter 44, it slows even further while turning the corner and beginning to rise inside chimney 43. One having ordinary skill in the art will recognize that fluid F at this point is primarily an admix of oil and water 3, gas 1 having already separated out and risen into chimney 43. Fluid F rises until it approaches mouth 34, where it recombines with a layer of gas 1 and exits separator 10 through fluid outlet 31.

Thus, the helical circulation of fluid F within tank 10 substantially increases the overall length of its pathway while it is in tank 10. This in turn substantially increases the drop in speed of fluid F and maximizes the time debris 5 has to settle out of fluid F. Further, such a helical path, and the circular manner in which the present invention induces it, increases the laminar nature of the flow of fluid F, further stabilizing and calming it for debris 5 to settle out. This is in contrast to most prior art which directs fluid F straight toward a deflector plate which abruptly interrupts fluid F and diverts it downward toward the bottom of tank 10, causing considerable non-laminar turbulence and disrupting the settlement action of debris 5.

While the invention has been particularly shown and described with reference to one or more particular embodiments, it will be understood by those skilled in the art that various changes in form and detail may be made therein without departing from the spirit and scope of the invention. For example, though separator 10 has been discussed above in the context of natural gas exploration and production, it works as well for petroleum exploration and production. The lighter constituents of fluid F in this context are primarily petroleum, which escape into flue 40 around perimeter 44 and recombines at mouth 34 with fluid F substantially freed of sand 5, as discussed for natural gas 1. Also, tank 10 has been depicted and discussed as being spherical in shape, with its walls substantially circular in cross section, but it could comprise other shapes, such as ovate, tetrahedral or even cubical, as long as its interior 14 did not create so much turbulence that it overcomes the slowing and calming effect of the helical rotation of fluid F for the purpose of letting debris 5 settle out for removal.

1. A sand separator for removing solid debris from oil and gas wellhead fluid, the sand separator comprising
a tank having a vertical axis extending between a tank dome and a tank basin, said tank having a tank interior and tank interior walls;
a fluid inlet adapted to couple to said wellhead and having
an interior nozzle coupled to said fluid inlet and in fluid communication with said wellhead, said interior nozzle extending into said tank interior a spaced distance;
a deflector coupled to said interior nozzle distal said fluid inlet and adapted to direct said fluid toward an impact location on said tank interior walls located at a select angular displacement about said vertical axis from said fluid inlet; and
erosion retardation means disposed on said tank interior walls at said impact location;
a fluid outlet disposed at a top of said tank dome and having
a downcomer coupled to said fluid outlet and extending coaxially into said tank interior a spaced distance, said downcomer having a downcomer mouth;
a flue coupled to said downcomer between said downcomer mouth and said fluid outlet, said flue having
a flue top surface and an opposite flue bottom surface;
an annular margin disposed a spaced distance below said downcomer mouth; and
an annular collar disposed on said flue bottom surface a spaced distance within and concentric with said annular margin and said vertical axis; and
a sand outlet.

2. The sand separator of claim 1 wherein
each of said tank dome and said tank basin is hemispherical, whereby said tank is spherical and having spherical tank interior walls.

3. The sand separator of claim 1 wherein said annular margin further comprises
a plurality of margin notches.

4. The sand separator of claim 3 wherein said annular collar further comprises
a plurality of scalloped collar recesses.

5. The sand separator of claim 1 wherein said annular collar further comprises
a plurality of scalloped collar recesses.

6. The sand separator of claim 1 and further comprising
a plurality of margin notches disposed around said annular margin; and
a plurality of scalloped collar recesses disposed around said annular collar.

7. The sand separator of claim 6 wherein
said a plurality of scalloped collar recesses are displaced about said vertical axis a spaced angular distance relative to said margin notches.

8. The sand separator of claim 1 wherein said sand outlet comprises
a sand exit port disposed coaxial with said vertical axis and extending through said tank basin;
valve means for opening and closing said sand exit port; and
a sand shield disposed above said sand exit port.

9. The sand separator of claim 8 wherein said sand shield further comprises
a plate disposed normal to said vertical axis above said sand exit port; and
a plurality of legs disposed between said plate and said sand exit port and adapted to support said plate a spaced distance above said sand exit port.

10. The sand separator of claim 1 wherein said erosion retardation means comprises
a shield plate coupled to said interior wall at said impact location and adapted to cause said wellhead fluid to be redirected into a helical path around said tank top and downward into said tank bottom.

11. The sand separator of claim 10 wherein said shield plate comprises
a concave dish welded to said tank interior walls astraddle said impact location, said concave dish extending a spaced distance on both sides and above and below said impact location.

12. The sand separator of claim 1 wherein said select angular displacement comprises
a continuous range of angles between forty five degrees and one hundred thirty-five degrees.

13. The sand separator of claim 12 wherein said select angular displacement comprises
approximately ninety degrees.

14. A sand separator for removing solid debris from oil and gas wellhead fluid, the sand separator comprising
a tank adapted to couple to said wellhead, said tank having a vertical axis, a bottom basin and a top dome surrounding said vertical axis and defining a tank interior, said tank interior having tank interior walls;
a fluid inlet between said wellhead and said tank interior, said inlet having
an exterior inlet port adapted to couple to said wellhead;
an interior nozzle in fluid communication with said wellhead and extending from said exterior inlet port through said top dome into said tank interior;
a deflector coupled to said interior nozzle distal said exterior inlet port, said deflector adapted to direct said fluid toward an impact location on said tank interior walls, said impact location being located at a select angular displacement substantially less than one hundred eighty degrees about said vertical axis from said exterior inlet port; and
erosion retardation means disposed on said tank interior walls at said impact location;
a fluid outlet having
an exterior outlet port;
a downcomer coupled to said exterior outlet port and extending coaxially into said tank interior a spaced distance, said downcomer having a downcomer mouth;
a conical flue coupled to said downcomer between said downcomer mouth and said exterior outlet port, said conical flue having
a flue top surface and an opposite flue bottom surface;
an annular margin disposed a spaced distance below said downcomer mouth and extended a select horizontal, radial distance from said vertical axis; and
an annular collar coaxial disposed on said flue bottom surface a spaced distance within and concentric with said annular margin; and
a sand outlet.

15. A method of removing solid debris from oil and gas wellhead fluid comprising
providing a sand separator having
a tank having a vertical axis extending between a tank dome and a tank basin, said tank having a tank interior and tank interior walls;
a fluid inlet adapted to couple to said wellhead and having
an interior nozzle coupled to said fluid inlet and in fluid communication with said wellhead, said interior nozzle extending into said tank interior a spaced distance;
a deflector coupled to said interior nozzle distal said fluid inlet and adapted to direct said fluid toward an impact location on said tank interior walls located at a select angular displacement about said vertical axis from said fluid inlet; and
erosion retardation means disposed on said tank interior walls at said impact location;
a fluid outlet disposed at said tank top and having
a downcomer coupled to said fluid outlet and extending coaxially into said tank interior a spaced distance, said downcomer having a downcomer mouth;
a flue coupled to said downcomer between said downcomer mouth and said fluid outlet, said flue having
a flue top surface and an opposite flue bottom surface;
an annular margin disposed a spaced distance below said downcomer mouth; and
an annular collar disposed on said flue bottom surface a spaced distance within and concentric with said annular margin and said vertical axis; and
a sand outlet; then
positioning said sand separator on a resting surface adjacent said wellhead; then
coupling said sand separator to said wellhead; then
substantially simultaneously
opening said wellhead and permitting wellhead fluid to enter said tank interior through said fluid inlet; and
opening said fluid outlet to permit oil and gas fluid out of said tank interior for further processing; and
periodically opening said sand outlet and permitting wellhead pressure to expel sand and solid debris out of said tank interior.

16. The method of claim 15 wherein
each of said tank dome and said tank basin is hemispherical, whereby said tank is spherical and having spherical tank interior walls.

17. The method of claim 15 wherein said sand separator further comprises
a plurality of margin notches disposed around said annular margin; and
a plurality of scalloped collar recesses disposed around said annular collar.

18. The method of claim 17 wherein
said a plurality of scalloped collar recesses are displaced about said vertical axis a spaced angular distance relative to said margin notches

19. The method of claim 15 wherein said erosion retardation means comprises
a shield plate coupled to said interior wall at said impact location and adapted to direct said wellhead fluid into a helical path around said tank top and downward into said tank bottom.

20. The method of claim 15 wherein said sand outlet comprises
a sand exit port disposed coaxial with said vertical axis and extending through said tank basin; and
a sand shield disposed above said sand exit port.

21. The sand separator of claim 20 wherein said sand shield further comprises
a plate disposed normal to said vertical axis above said sand exit port; and
a plurality of legs disposed between said plate and said sand exit port and adapted to support said plate a spaced distance above said sand exit port.
